(19) United States
(12) Patent Application Publication
(10) Pub. No.: US 2005/0061236 A1
(43) Pub. Date: Mar. 24, 2005

(54) Bar coating apparatus

(75) Inventors: Hisakazu Ijima, Tokyo (JP); Yutaka Shimizu, Tokyo (JP)

Correspondence Address: SEED INTELLECTUAL PROPERTY LAW GROUP PLLC, 701 FIFTH AVE, SUITE 6300, SEATTLE, WA, 98104-7092, US

(73) Assignee: TDK Corporation, Tokyo (JP)

(21) Appl. No.: 10/911,992

(22) Filed: Aug. 5, 2004

(30) Foreign Application Priority Data
Aug. 8, 2003 (JP) 2003-290289

(51) Int. Cl. B05D 5/12; B05C 1/06; B05C 11/00

(52) U.S. Cl. 118/258; 118/261; 118/263

(57) ABSTRACT

A bar coating apparatus includes a rotatable bar, a supporting block adapted for supporting the bar and formed with a slit through which the coating solution is fed at an upstream portion of the bar and a pair of side plates disposed on the opposite sides of the supporting block with respect to a widthwise direction of a flexible support to be coated with a coating solution, the bar, the supporting block and the pair of side plates being disposed so as to form a liquid pool of the coating solution fed through the slit formed in the supporting block in a space defined by the bar, the supporting block and the pair of side plates. According to the thus constituted bar coating apparatus, it is possible to transfer a desired amount of the coating solution onto the surface of the flexible support without forming the slit with high accuracy.

### BACKGROUND OF THE INVENTION

The present invention relates to a bar coating apparatus and, particularly, to a bar coating apparatus which can be manufactured at low cost, control the amount of a coating solution transferred onto the surface of a flexible support in a desired manner and reliably prevent coating solution accommodated in a spiral groove formed on the surface of a bar, coating solution adhered to the surface of a bar and coating solution accompanying the surface of a bar from being transferred onto the surface of the flexible support, thereby controlling the thickness of a coating layer in a desired manner.

### DESCRIPTION OF THE PRIOR ART

There is known a bar coating method for forming a coating layer having a desired thickness on the surface of a flexible support by extruding a coating solution onto the surface of the flexible support on which a coating layer is to be formed, thereby forming a coating layer, pushing a rotating bar formed with a spiral groove on the surface thereof onto the coating layer, scraping excessive coating solution off from the coating layer and metering an amount of the coating solution.

The bar coating method is widely used since a relatively good coating layer can be formed using an apparatus having a simple structure with simple operation.

Wide use has been made of a bar coating apparatus equipped with a coating solution transferring section for directly extruding a coating solution from a slit onto the surface of a flexible support, thereby transferring the coating solution there onto, and with a separate coating solution metering section for scraping excessive coating solution transferred onto the surface of the flexible support using a bar to meter an amount of the coating solution. On the other hand, in order to make the bar coating apparatus compact, there has been proposed a bar coating apparatus in which a coating solution transferring section for directly extruding a coating solution from a slit onto the surface of a flexible support, thereby transferring the coating solution there onto, and a coating solution metering section for scraping excessive coating solution transferred onto the surface of the flexible support using a bar to meter an amount of the coating solution are integrated (For example, Japanese Patent Application Laid Open No. 6-296922 and the like).

However, in the case of directly extruding a coating solution from a slit onto the surface of a flexible support, thereby transferring the coating solution thereonto, it is indispensable to fabricate the slit with high accuracy in order to control the amount of coating solution transferred onto the surface of the flexible support in a desired manner and therefore, the cost of manufacturing the bar coating apparatus inevitably increases.

Further, in the bar coating apparatus in which a coating solution transferring section for directly extruding a coating solution from a slit onto the surface of a flexible support, thereby transferring the coating solution thereonto, is integrated with a coating solution metering section for scraping off excessive coating solution transferred onto the surface of the flexible support using a bar to meter the amount of the coating solution, coating solution discharged through the slit is held in a spiral groove formed on the surface of the bar, adhered to the surface of the bar or accompanies the surface of the bar and may be transferred onto the surface of the flexible support. However, in such a case, since the thickness of the coating layer becomes uneven, the thickness of the coating layer cannot be controlled in a desired manner.

### SUMMARY OF THE INVENTION

It is therefore an object of the present invention to provide a bar coating apparatus which can be manufactured at low cost and control the amount of a coating solution transferred onto the surface of a flexible support.

It is another object of the present invention to provide a bar coating apparatus which can reliably prevent coating solution accommodated in a spiral groove formed on the surface of a bar, coating solution adhered to the surface of a bar and coating solution accompanying the surface of a bar from being transferred onto the surface of a flexible support, thereby controlling the thickness of a coating layer in a desired manner.

The above and other objects of the present invention can be accomplished by a bar coating apparatus including a rotatable bar, a supporting block adapted for supporting the bar and formed with a slit through which the coating solution is fed at an upstream portion of the bar with respect to a transportation direction of a flexible support to be coated with a coating solution and a pair of side plates disposed on the opposite sides of the supporting block with respect to a widthwise direction of the flexible support, the bar, the supporting block and the pair of side plates being disposed so as to form a liquid pool of the coating solution fed through the slit formed in the supporting block in a space defined by the bar, the supporting block and the pair of side plates.

According to the present invention, since the bar coating apparatus includes a rotatable bar, a supporting block adapted for supporting the bar and formed with a slit through which the coating solution is fed at an upstream portion of the bar with respect to a transportation direction of a flexible support to be coated with a coating solution and a pair of side plates disposed on the opposite sides of the supporting block with respect to a widthwise direction of the flexible support, and the bar, the supporting block and the pair of side plates are disposed so that the coating solution fed through the slit formed in the supporting block forms a liquid pool of a coating solution fed through the slit in a space defined by the bar, the supporting block and the pair of side plates, it is possible to transfer a desired amount of the coating solution onto the surface of the flexible support without forming the slit with high accuracy.

In a preferred aspect of the present invention, the bar coating apparatus further comprises a pair of solvent feeding devices disposed outside of the side plates with respect to the widthwise direction of the flexible support and outside of opposite edge portions of a coating layer of the coating solution to be formed on the surface of the flexible support and adapted for feeding a solvent capable of dissolving the coating solution onto the surface of the bar.

A part of a coating solution accommodated in the spiral groove formed on the surface of the bar, coating solution adhered to the surface of the bar and coating solution accompanying the surface of the bar may spread in the widthwise direction of the flexible support to be transferred onto the surface of the flexible support and adhered to a region of the flexible support on which a coating layer should not be formed and in such a case, parts of the coating solution adhered to the opposite edge portions of the flexible support adhere to themselves when the flexible support is wound up and there is a risk of the flexible support being torn when the flexible support is unwound. However, according to this preferred aspect of the present invention, since the bar coating apparatus further comprises a pair of solvent feeding devices disposed outside of the side plates with respect to the widthwise direction of the flexible support and outside of opposite edge portions of a coating layer of the coating solution to be formed on the surface of the flexible support and adapted for feeding a solvent capable of dissolving the coating solution onto the surface of the bar, even in the case where a part of a coating solution accommodated in the spiral groove formed on the surface of the bar, coating solution adhered to the surface of the bar and coating solution accompanying the surface of the bar spread in the widthwise direction of the flexible support, the coating solution spread in the widthwise direction is dissolved by the solvent fed onto the surface of the bar and transferred onto the surface of the flexible support. Nevertheless, since the solvent dissolving the coating solution and transferred onto the surface of the flexible support is removed during a drying process, it is possible to reliably prevent parts of the coating solution adhered to the opposite edge portions of the flexible support outside of a region to be coated from adhering to themselves and the flexible support from being torn when the flexible support is unwound.

In a further preferred aspect of the present invention, the bar coating apparatus further comprises a doctor blade abutting against the surface of the bar on a side opposite to the slit and having a width larger than that of the liquid pool and the pair of solvent feeding devices is disposed inside of opposite edge portions of the doctor blade.

According to this preferred aspect of the present invention, since the bar coating apparatus further includes the doctor blade abutting against the surface of the bar on a side opposite to the slit and having a width larger than that of the liquid pool, coating solution accommodated in the spiral groove formed on the surface of the bar, coating solution adhered to the surface of the bar and coating solution accompanying the surface of the bar can be scraped off from the surface of the bar by the doctor blade and collected. Therefore, since it is possible to reliably prevent coating solution accommodated in the spiral groove formed on the surface of the bar, coating solution adhered to the surface of the bar and coating solution accompanying the surface of the bar from being transferred onto the surface of the flexible support, it is possible to control the thickness of the coating layer in a desired manner.

Further, even when coating solution accommodated in the spiral groove formed on the surface of the bar, coating solution adhered to the surface of the bar and coating solution accompanying the surface of the bar are scraped off by the doctor blade having a width larger than that of the liquid pool, a part of the coating solution scraped off by the doctor blade may remain on the surface of the bar and spread in a widthwise direction to be transferred onto and adhere to a surface region of the flexible support which should not be coasted with a coating solution and in such a case, parts of the coating solution adhered to the opposite edge portions of the flexible support adhere to each other when the flexible support is reeled off and there is a risk of the flexible support being torn when the flexible support is unwound. However, according to this preferred aspect of the present invention, since the bar coating apparatus includes the pair of solvent feeding devices disposed inside of opposite edge portions of the doctor blade, even when a part of the coating solution scraped off by the doctor blade remains on the surface of the bar and spreads in a widthwise direction to be transferred onto and adhere to a surface region of the flexible support which should not be coasted with a coating solution, the coating solution adhering to the surface region of the flexible support which should not be coasted with a coating solution is dissolved by a solvent fed onto the surface of the bar from the solvent feeding devices and the solvent dissolving the coating solution is removed during a drying process. Therefore, it is possible to reliable prevent coating solutions adhering to the surface region of the flexible support which should not be coasted with a coating solution from adhering to themselves and the flexible support from being torn when the flexible support is unwound.

In a preferred aspect of the present invention, the pair of side plates are disposed inside of opposite edge portions of the flexible support to be coated with the coating solution.

According to this preferred aspect of the present invention, since the pair of side plates are disposed inside of opposite edge portions of the flexible support to be coated with the coating solution, the width of the liquid pool formed by the coating solution can be restricted by the pair of side plates and regions coated with no coating solution can be left at the opposite edge portions of the flexible support. Therefore, when the flexible support formed with the coating layer is reeled off, it is possible to reliably prevent the coating layers formed at the opposite edge portions of the flexible support from adhering to themselves and the flexible support from being torn when the flexible support is unwound.

In a preferred aspect of the present invention, the bar coating apparatus further comprises a drain passage adapted for discharging the coating solution and formed in the supporting block below the bar.

According to this preferred aspect of the present invention, since the drain passage is formed in the supporting block below the bar for discharging the coating solution, a part of the coating solution accommodated in the spiral groove formed on the surface of the bar, coating solution adhered to the surface of the bar and coating solution accompanying the surface of the bar flows into the drain passage to be collected. Further, since the bar coating apparatus includes a doctor blade abutting against the surface of the bar on a side opposite to the slit, coating solution which has not flowed into the drain passage and has not been collected is scraped off by the doctor blade from the surface of the bar and flows into the drain passage to be collected. Therefore, it is possible to reliably prevent coating solution accommodated in the spiral groove formed on the surface of the bar, coating solution adhered to the surface of the bar and coating solution accompanying the surface of the bar from being transferred onto the surface of the flexible support and control the thickness of a coating layer in a desired manner.

In a further preferred aspect of the present invention, the lower end portion of the drain passage is formed so as to be inclined downwardly.

In a further preferred aspect of the present invention, each of the pair of side plates is formed with a cut portion and the bar extends through the cut portions.

In another preferred aspect of the present invention, each of the pair of side plates is formed with an opening and the bar extends through the openings.

In a preferred aspect of the present invention, a top portion of the support block has a substantially triangular shaped cross section at an upstream portion of the bar.

According to this preferred aspect of the present invention, since a top portion of the support block has a substantially triangular shaped cross section at an upstream portion of the bar, it is possible to form a liquid pool including a sufficient amount of the coating solution between the bar, the support block and the pair of side plates and, therefore, a desired amount of the coating solution can be transferred onto the surface of the flexible support without forming a slit with high accuracy.

In a further preferred aspect of the present invention, the support block includes a first support block for supporting the bar and a second support block whose top portion has a substantially triangular shaped cross section, the slit is formed between the first support block and the second support block, and the bar, the first support block, the second support block and the pair of side plates are disposed so that a coating solution fed through the slit formed in the support block forms the liquid pool in a space defined by the bar, the top portion of the second support block and the pair of side plates.

According to this preferred aspect of the present invention, since the support block includes a first support block for supporting the bar and a second support block having the top portion having a substantially triangular shaped cross section, the slit is formed between the first support block and the second support block, and the bar, the first support block, the second support block and the pair of side plates are disposed so that a coating solution fed through the slit formed in the support block forms the liquid pool in a space defined by the bar, the top portion of the second support block and the pair of side plates, it is possible to form a liquid pool including a sufficient amount of the coating solution between the bar, the support block and the pair of side plates and, therefore, a desired amount of the coating solution can be transferred onto the surface of the flexible support without forming a slit with high accuracy.

In a further preferred aspect of the present invention, the first support block is made of a metal softer than that of the bar.

According to this preferred aspect of the present invention, since the first support block is made of a metal softer than that of the bar, it is possible to effectively prevent the bar from being galled due to the contact with the first support block and the thickness of the coating layer from varying with the lapse of time.

The above and other objects and features of the present invention will become apparent from the following description made with reference to the accompanying drawings.

### BRIEF DESCRIPTION OF THE DRAWINGS

FIG. 1 is a schematic cross-sectional view showing a bar coating apparatus which is a preferred embodiment of the present invention.

FIG. 2 is a schematic center cross-sectional view taken along a line A-A in FIG. 1.

FIG. 3 is a schematic partial side view of a bar coating apparatus shown in FIG. 1.

FIG. 4 is a schematic front view showing a bar pressing device.

FIG. 5 is a schematic partial perspective view of a bar coating apparatus showing the vicinity of one of the solvent extruders.

### DESCRIPTION OF THE PREFERRED EMBODIMENTS

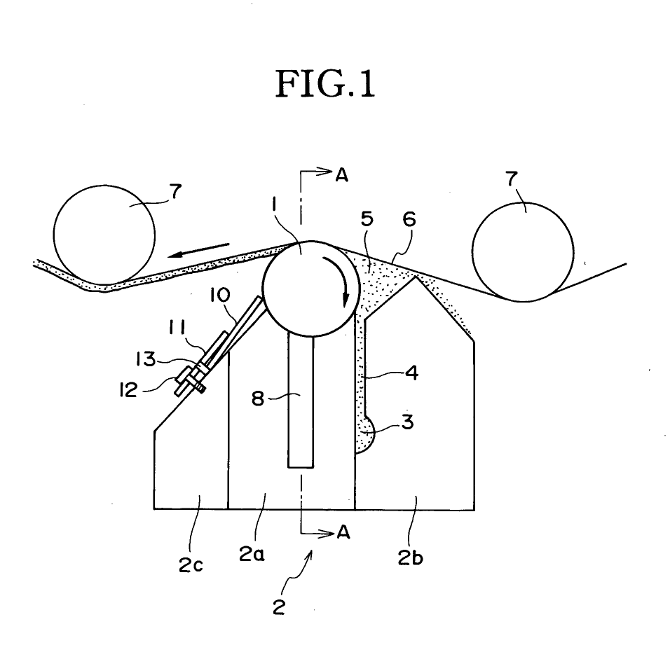

FIG. 1 is a schematic cross-sectional view showing a bar coating apparatus which is a preferred embodiment of the present invention.

As shown in FIG. 1, a bar coating apparatus according to this embodiment includes a bar 1 formed with a spiral groove (not shown) on the surface thereof and a support block 2 for supporting the bar 1.

The bar 1 has a diameter of about 10 mm, for example.

As shown in FIG. 1, in this embodiment, the support block 2 includes a first support block 2a, a second support block 2b and a third support block 2c integrally formed with each other and a slit 4 is formed between the first support block 2a and the second support block 2b and adapted for feeding a coating solution via a pocket 3.

In this embodiment, the bar 1 is made of a stainless steel which can be processed with high accuracy and the first support block 2a against which the bar abuts is made of a softer material such as brass, copper or the like than stainless steel in order to prevent the bar 1 from galling. On the other hand, the second support block 2b and the third support block 2c against which the bar 1 does not abut are made of a stainless steel.

As shown in FIG. 1, the top portion of the second support block 2b has a substantially triangular cross section and a liquid pool 5 of a coating solution fed through the slit 4 is formed between the top portion of the second support block 2b and the bar 1.

The bar 1 is rotated in the opposite direction to the transportation direction of a flexible support 6, namely, clockwise in FIG. 1, and the flexible support 6 formed of polyethylene terephthalate or the like is transported while being strongly pressed by guide rollers 7, 7 onto the surface of the bar 1.

In this embodiment, the upstream guide roller 7a and the downstream guide roller 7b are respectively movable by an upstream guide roller moving means (not shown) and a downstream guide roller moving means (not shown) between their coating positions shown in FIG. 1, namely, positions where a coating solution can be transferred onto the surface of the flexible support 6 and their retracted positions above their coating positions.

As shown in FIG. 1, the first support block 2a is formed with a drain passage 8 for discharging excessive coating solution below the bar 1. The lower end portion of the drain passage 8 extends widthwise and is inclined downwardly so that a coating solution flowing into the drain passage 8 can be easily collected.

As shown in FIG. 1, a doctor blade 10 is mounted on the third support block 2c for scraping a coating solution adhered to the surface of the bar 1 and a coating solution accompanying the surface of the bar 1.

Although not shown in FIG. 1, the width of the doctor blade 10 is larger than that of the liquid pool 5 and in this embodiment, the doctor blade 10 is formed of polyester resin.

As shown in FIG. 1, in this embodiment, a blade pressing plate 11 is secured by a screw 12 to the third support block 2c. The doctor blade 10 is inserted into a space between the first support block 2a and the third support block 2c, and the blade pressing plate 11 until it comes into abutment with a positioning pin 13 penetrating the blade pressing plate 11 and when the doctor blade 10 comes into abutment with the positioning pin 13, the screw 12 is fastened, whereby the doctor blade 10 is fixed onto the first support block 2a and the third support block 2c.

Although not shown in FIG. 1, a pair of solvent extruders is provided inside of opposite edge portions of the doctor blade 10 for feeding a solvent capable of dissolving a coating solution onto the surface of the bar 1 from the lower side.

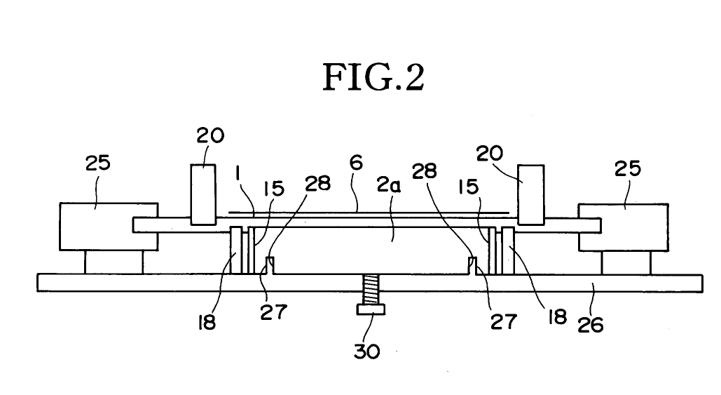

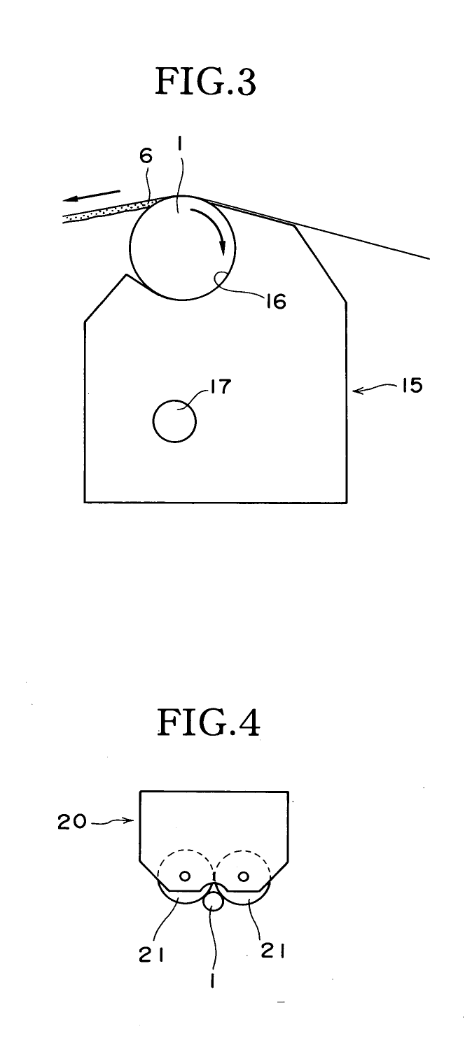

FIG. 2 is a schematic center cross-sectional view taken along a line A-A in FIG. 1 and FIG. 3 is a schematic partial side view of a bar coating apparatus shown in FIG. 1.

As shown in FIGS. 2 and 3, a pair of side plates 15, 15 is disposed inside of opposite edge portions of the flexible support 6 for defining opposite end portions of the liquid pool 5 and the bar 1 extends to opposite sides of the pair of side plates 15, 15 through cut portions 16 formed in the pair of side plates 15, 15.

In the case where the upper portions of the side plates 15, 15 come into contact with the flexible support 6, since there is a risk of static electrical charge being generated, the pair of side plates 15, 15 is disposed so as to form a small gap between the upper portions thereof and the flexible support 6, for example, 0.1 mm.

In this embodiment, the side plates 15, 15 are made of polytetrafluoroethylene.

As shown in FIG. 3, the cut portions 16 are shaped so that the bar 1 can be easily attached to or removed from the bar coating apparatus via the cut portions 16.

As shown in FIG. 3, each of the pair of side plates 15, 15 is formed with an opening 17 and the drain passage 8 extends through the openings 17.

As shown in FIG. 2, a pair of extrusion type solvent extruders 18, 18 is provided outside of the pair of side plates 15, 15 for feeding a solvent capable of dissolving a coating solution onto the surface of the bar 1 from the lower side.

Although not shown in FIG. 2, each of the pair of solvent extruders 18, 18 is disposed inside of the opposite edge portions of the doctor blade 10 having a width larger than that of the liquid pool 5.

As shown in FIG. 2, at portions of the bar 1 outside of the pair of solvent extruders 18, 18, bar pressing devices 20, 20 are provided so as to abut against the bar 1.

FIG. 4 is a schematic front view showing the bar pressing device 20.

As shown in FIG. 4, each of the bar pressing devices 20 includes two rubber rollers 21, 21 each of which can be moved vertically by a driving mechanism (not shown) and driven and the portions of the bar 1 outside of the pair of side plates 15, 15 are pressed by the two rubber rollers 21, 21, whereby the bar 1 is prevented from being bent when it is rotated.

As shown in FIGS. 1 and 2, the first support block 2a, the second support block 2b and the third support block 2c are mounted onto a base plate 26 to which a bar driving mechanism 25 are fixed.

As shown in FIG. 2, the upper surface of the base plate 26 is formed with two positioning pins 27, 27 and on the other hand, the lower surface of the first support block 2a is formed with two positioning holes 28, 28.

Therefore, when the support block 2 is fixed to the base plate 26, the support block 2 is positioned on the base plate 26 so that the two positioning pins 27, 27 of the base plate 26 are inserted into the two positioning holes 28, 28 of the first support block 2a and the support block 2 is fixed to the base plate 26 by a setscrew (not shown).

As shown in FIG. 2, an adjusting screw 30 is provided at the central portion of the base plate 26 so that the central portion of the lower surface of the first support block 2a fixed to the base plate 26 can be pushed upward by the adjusting screw 30.

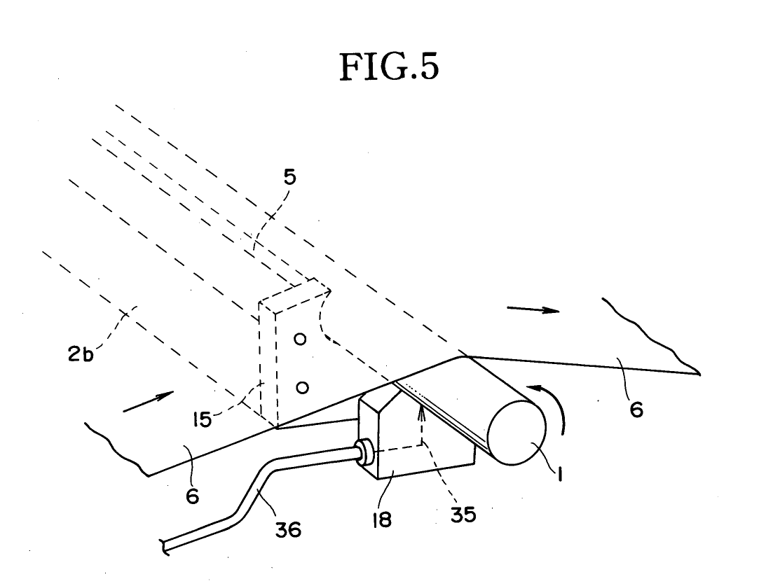

FIG. 5 is a schematic partial perspective view of a bar coating apparatus showing the vicinity of one of the solvent extruders, the bar pressing device 20 being omitted from FIG. 5.

As shown in FIG. 5, each of the solvent extruders 18, 18 is constituted as an extrusion type coating device and adapted to feed a solvent 35 capable of dissolving a coating solution onto the surface of the bar 1 from its lower side at a region of the bar 1 corresponding to a region outside of one of the opposite edge portions of the coating layer to be formed by applying a coating solution onto the flexible support 6.

The kind of the solvent 35 is not particularly limited insofar as it can dissolve a coating solution.

The solvent 35 is stored in a solvent tank (not shown) disposed above the bar coating apparatus and is fed to the solvent extruders 18, 18 via pipes 36 utilizing the communicating tube principle.

In the case where the surface of the flexible support 6 is coated with a coating solution using the thus constituted bar coating apparatus, the first support block 2a is first mounted on the base plate 26 on which the bar driving mechanism 25 is fixed.

At this time, the upstream guide roller 7a and the downstream guide roller 7b are held at their retracted positions above their coating positions.

When the support block 2 is fixed to the base plate 26, the support block 2 is positioned on the base plate 26 so that the two positioning pins 27, 27 formed on the upper surface of the base plate 26 are inserted into the two positioning holes 28, 28 of the first support block 2a and the support block 2 is fixed to the base plate 26 by a setscrew (not shown).

In this manner, since the support block 2 is positioned on the base plate 26 so that the two positioning pins 27, 27 formed on the upper surface of the base plate 26 are inserted into the two positioning holes 28, 28 of the first support block 2a and the support block 2 is fixed to the base plate 26, the support block 2 can be positioned at a desired position on the base plate 26 and fixed to the base plate 26.

Then, the bar 1 is set in the bar driving mechanism 25 so as to be located on the first support block 2a.

Further, the doctor blade 10 is inserted into a space between the first support block 2a and the third support block 2c, and the blade pressing plate 11 until it comes into abutment with the positioning pin 13 penetrating the blade pressing plate 11 and when the doctor blade 10 comes into abutment with the positioning pin 13, the screw 12 is fastened, whereby the doctor blade 10 is fixed onto the first support block 2a and the third support block 2c.

Then, a coating solution is fed by a pump (not shown) to the slit 4 via the pocket 3 to form a liquid pool 5.

Afterward, each of the bar pressing devices 20 are lowered and portions of the bar 1 outside of the pair of side plates 15, 15 are pressed by the pair of rubber rollers 21, 21 of each of the bar pressing devices 20.

When the supporting block 2, the bar 1, the doctor blade 10 and the bar pressing devices 20 have been set in this manner, the flexible support 6 is strongly pressed onto the surface of the bar 1 and the bar 1 is rotated by the bar driving mechanism 25.

At the same time, a solvent 35 is applied from the pair of solvent extruders 18, 18 onto the surface of the bar 1 from its lower side at regions of the bar 1 corresponding to regions outside of opposite edge portions of a coating layer to be formed by applying a coating solution onto the flexible support 6.

The pair of rubber rollers 21, 21 of each of the bar pressing devices 20, 20 are rotated as the bar 1 is rotated.

The flexible support 6 is transported by the transporting means (not shown) and since the flexible support 6 is strongly pressed onto the surface of the bar 1 by the guide roller 7, even if the flexible support 6 has local deformation such as local sagging, it is possible to coat the lower surface of the flexible support 6 with a coating solution and form a coating layer on the lower surface of the flexible support 6 in a desired manner.

In this embodiment, an amount of coating solution larger than that to be applied onto the lower surface of the flexible support 6, for example, 1.1 to 1.5 times the amount of the coating solution to be applied onto the lower surface of the flexible support 6, is fed.

Here, since the coating solution is fed via the pocket 3, the pressure fluctuation of a pump can be absorbed.

The slit 4 is formed so as to have a width of about 0.1 mm to about 0.2 mm in order to decrease the flow rate distribution of the coating solution fed through the slit 4 in the width direction.

Since the top portion of the second support block 2b has a substantially triangular cross section, the coating solution fed through the slit 4 forms a liquid pool 5 in the space between the top portion of the second support block 2b, the bar 1 and the pair of side plates 15, 15 and the coating solution forming the liquid pool 5 is transferred onto the lower surface of the flexible support 6.

In this manner, since the coating solution fed through the slit 4 forms a liquid pool 5 in a space between the top portion of the second support block 2b, the bar 1 and the pair of side plates 15, 15 and the coating solution forming the liquid pool 5 is transferred onto the lower surface of the flexible support 6, even in the case where the slit 4 is not fabricated with high accuracy so as to have a predetermined width, a desired amount of coating solution can be transferred onto the lower surface of the flexible support 6.

In this embodiment, since an amount of coating solution larger than that to be applied onto the lower surface of the flexible support 6, for example, 1.1 to 1.5 times the amount of the coating solution to be applied onto the lower surface of the flexible support 6, is fed, a part of the coating solution goes over the top portion of the second support block 2b and flows along the surface of the second support block 2b on the side opposite to the liquid pool 5, thereby being collected in a coating solution collecting section (not shown).

The coating solution transferred onto the lower surface of the flexible support 6 is metered by the bar 1 rotating clockwise in FIG. 1.

In this embodiment, since the width of the liquid pool 5 of the coating solution is restricted by the side plates 15, 15, it is possible to leave a region coated with no coating solution at the opposite edge portions of the flexible support 6. Therefore, when the flexible support 6 formed with a coating layer is reeled off, it is possible to reliably prevent the coating layers formed at the opposite edge portions of the flexible support 6 from adhering to themselves and the flexible support 6 from being torn when the flexible support is unwound.

Since the bar 1 is rotated while it abuts against the upper surface of the first support block 2a, a coating solution adhered to the surface of the bar 1 rotating clockwise in FIG. 1 and a coating solution accompanying the surface of the bar 1 are to be scraped off by the first support block 2a under normal conditions. However, since the bar 1 is generally slender in such a manner that the diameter thereof is about 10 mm, for example, and it tends to be warped or bent, the bar 1 is rotated in such a manner that the central portion thereof is eccentric. As a result, there arises a risk of a part of the coating solution adhered to the surface of the bar 1 or the coating solution accompanying the surface of the bar 1 being carried by the bar 1 without being scraped off by the first support block 2a and being transferred onto the surface of the flexible support 6 at the downstream of the bar 1.

However, in this embodiment, since the first support block 2a below the bar 1 is formed with the drain passage 8, the coating solution adhered to the surface of the bar 1 or the coating solution accompanying the surface of the bar 1 without being scraped off by the first support block 2a flows into the drain passage 8 together with a coating solution accommodated in a spiral groove formed on the surface of the bar 1 and is collected through the lower end portion of the drain passage 8 inclined downwardly. Therefore, it is possible to effectively prevent coating solution accommodated in the spiral groove formed on the surface of the bar 1, coating solution adhered to the surface of the bar 1 or coating solution accompanying the surface of the bar 1 from being transferred onto the surface of the flexible support 6 at the downstream portion of the bar 1.

Further, in this embodiment, since the doctor blade 10 formed so as to have a width larger than that of the liquid pool 5 and adapted for scraping off the coating solution adhered to the surface of the bar 1 and the coating solution accompanying the surface of the bar 1 is mounted on the third support block 2c, coating solution which has not flowed into the drain passage 8 and not been collected among the coating solution adhered to the surface of the bar 1 and the coating solution accompanying the surface of the bar 1 is scraped off by the doctor blade 10 and flows into the drain passage 8 to be collected. Therefore, it is possible to reliably prevent coating solution adhered to the surface of the bar 1 or coating solution accompanying the surface of the bar 1 from being transferred onto the surface of the flexible support 6 at the downstream portion of the bar 1.

Furthermore, as described above, since the bar 1 is slender, it tends to be warped or bent and it is rotated in such a manner that the central portion thereof is eccentric. As a result, since the contact between the central portion of the bar 1 and the first supporting block 2a deteriorates, whereby the contact pressure between the flexible support 6 and the bar 1 decreases, the amount of coating solution scraped off by the bar 1 at the central portion of the bar 1 may become different from that at regions close to the opposite end portions of the bar 1 and there arises a risk of the thickness of a coating layer varying.

Therefore, in this embodiment, the adjusting screw 30 is provided at the central portion of the base plate 26 for pushing up the central portion of the lower surface of the first support block 2a made of brass so as to be softer than the stainless steel forming the bar 1 and fixed to the base plate 26 so that the central portion of the bar 1 is pressed by the adjusting screw 30 onto the flexible support 6 via the first support block 2a, thereby making the contact pressure between the flexible support 6 and the surface of the bar 1 uniform.

For example, an amount of pushing up of the first support block 2a is set to be about 1 mm.

The adjustment of the amount of pushing up of the first support block 2a may be performed prior to starting a coating operation or after a coating layer is formed and observed. Further, it is possible to tentatively adjust the amount of pushing up of the first support block 2a prior to starting a coating operation and fine adjust it after a coating layer is formed and observed.

Furthermore, in this embodiment, since the portions of the bar 1 outside of the pair of side plates 15, 15 are pressed by the two rubber rollers 21, 21 of each of the bar pressing devices 20, it is possible to prevent the bar 1 from being rotated in such a manner that the central portion thereof is eccentric.

Moreover, as described above, in this embodiment, the width of the liquid pool 5 is restricted by the pair of side plates 15, 15 so that regions coated with no coating solution can be left at the opposite edge portions of the flexible support 6 and the first supporting block 2a is formed with the drain passage 8 so that coating solution adhered to the surface of the bar 1 or coating solution accompanying the surface of the bar 1 which has not been scraped off by the first supporting block 2a can be collected through the drain passage 8 together with coating solution accommodated in the spiral groove formed on the surface of the bar 1. Further, the doctor blade 10 having a width larger than that of the liquid pool 5 is provided for scraping off coating solution adhered to the surface of the bar 1 and coating solution accompanying the surface of the bar 1 so that the coating solution adhered to the surface of the bar 1 and the coating solution accompanying the surface of the bar 1 which have not flowed into the drain passage 8 and have not been collected can be scraped off by the doctor blade 10 and collected through the drain passage 8. However, a part of the coating solution scraped off by the doctor blade 10 may remain on the surface of the bar 1 and spread in a widthwise direction to be transferred onto surface regions of the flexible support 6 which should not be coated with a coating solution and point-like adhered thereto and in such a case, parts of the coating solutions point-like adhered to regions at the opposite edge portions of the flexible support 6 which should not be coated with a coating solution adhere to themselves when the flexible support 6 on the surface of which a coating layer has been formed is reeled off and there is a risk of the flexible support 6 being torn when the flexible support 6 is unwound.

However, in this embodiment, since a solvent 35 capable of dissolving a coating solution is fed from the pair of the solvent extruders 18, 18 onto the surface of the bar 1 from its lower side at regions of the bar 1 corresponding to regions outside of opposite edge portions of the coating layer to be formed by applying a coating solution onto the flexible support 6, even in the case where a part of the coating solution scraped off by the doctor blade 10 remains on the surface of the bar 1 and spreads in the widthwise direction, the thus spread coating solution is dissolved by the solvent 35 fed onto the surface of the bar 1 and, therefore, it is possible to reliably prevent a part of the coating solution scraped off by the doctor blade 10 from being transferred onto surface regions of the flexible support 6 which should not be coated with a coating solution and point-like adhered thereto. The solvent 35 dissolving the coating solution is transferred from the bar 1 onto the opposite edge portions of the flexible support 6 but the solvent 35 evaporates and is removed during the drying process together with the coating solution dissolved therein.

Therefore, it is possible to prevent coating solutions point-like adhered to the opposite edge portions of the flexible support 6 from being adhered to themselves when the flexible support 6 is reeled off and prevent the flexible support 6 from being torn when the flexible support 6 is unwound.

The coating solution forming the liquid pool 5 is transferred onto the lower surface of the flexible support 6 in this manner and excessive coating solution is scraped off by the bar 1, whereby a coating layer is formed on the lower surface of the flexible support 6.

According to the above described embodiment, since the liquid pool 5 is formed by a coating solution in the space between the top portion of the second support block 2b, the bar 1 and the pair of side plates 15, 15 and the coating solution forming the liquid pool 5 is transferred onto the surface of the flexible support 6, it is possible to easily control the amount of coating solution transferred onto the surface of the flexible support 6 in comparison with the case where a coating solution is directly discharged from a slit onto the surface of the flexible support 6 to be transferred.

Further, according to the above described embodiment, since the pair of side plates 15, 15 is disposed inside of the opposite edge portions of the flexible support 6 for defining the opposite end portions of the liquid pool 5 and the width of the liquid pool 5 is restricted by the pair of side plates 15, 15, the coating width of the coating solution transferred onto the surface of the flexible support 6 can be restricted.

Moreover, according to the above described embodiment, since the first support block 2a is formed with a drain passage 8, a coating solution accommodated in the spiral groove formed on the surface of the bar 1, coating solution adhered to the surface of the bar 1 and a coating solution accompanying the surface of the bar 1 can be caused to flow in the drain passage 8 and collected through the lower end portion of the drain passage 8 formed to be inclined downwardly. Therefore, it is possible to effectively prevent coating solution accommodated in the spiral groove formed on the surface of the bar 1, coating solution adhered to the surface of the bar 1 and coating solution accompanying the surface of the bar 1 from being transferred onto the surface of the flexible support 6 at the downstream portion of the bar 1.

Further, according to the above described embodiment, since the doctor blade 10 having a width larger than that of the liquid pool 5 is mounted on the third supporting block 2c for scraping a coating solution adhered to the surface of the bar 1, a coating solution which has not flowed into the drain passage 8 and not been collected among the coating solution adhered to the surface of the bar 1 and the coating solution accompanying the surface of the bar 1 is scraped off by the doctor blade 10 and flows into the drain passage 8 to be collected. Therefore, it is possible to reliably prevent a coating solution adhered to the surface of the bar 1 or a coating solution accompanying the surface of the bar 1 from being transferred onto the surface of the flexible support 6 at the downstream portion of the bar 1.

Furthermore, according to the above described embodiment, since a solvent 35 capable of dissolving a coating solution is fed from the pair of the solvent extruders 18, 18 onto the surface of the bar 1 from its lower side at regions of the bar 1 corresponding to regions outside of opposite edge portions of the coating layer to be formed by applying a coating solution onto the flexible support 6, even in the case where a part of a coating solution scraped off by the doctor blade 10 remains on the surface of the bar 1 and spreads in the widthwise direction, the thus spread coating solution is dissolved by the solvent 35 fed onto the surface of the bar 1 and, therefore, it is possible to reliably prevent a part of the coating solution scraped off by the doctor blade 10 from being transferred onto surface regions of the flexible support 6 which should not be coated with the coating solution and adhering point-like thereto. Accordingly, it is possible to prevent parts of the coating solution point-like adhered to the opposite edge portions of the flexible support 6 from being adhered to themselves due to the fact that a part of the coating solution scraped off by the doctor blade 10 remains on the surface of the bar 1 and spreads in the widthwise direction to be transferred onto surface regions of the flexible support 6 which should not be coated with the coating solution when the flexible support 6 is reeled off and prevent the flexible support 6 from being torn when the flexible support 6 is unwound.

Further, according to the above described embodiment, since the doctor blade 10 is fixed to the third support block 2c by inserting it into a space between the first support block 2a and the third support block 2c, and the blade pressing plate 11 until it comes into abutment with the positioning pin 13 penetrating the blade pressing plate 11 and fastening the screw 12 after the doctor blade 10 comes into abutment with the positioning pin 13, the doctor blade 10 can be fixed to the third support block 2c by a simple operation.

Moreover, according to the above described embodiment, the adjusting screw 30 is provided at the central portion of the base plate 26 for pushing up the central portion of the lower surface of the first support block 2a made of brass so as to be softer than the stainless steel forming the bar 1 and fixed to the base plate 26 so that the central portion of the bar 1 can be pressed by the adjusting screw 30 onto the flexible support 6 via the first support block 2a. Therefore, even in the case where there is a risk of the bar 1 being rotated in such a manner that the central portion thereof is eccentric and the contact pressure between the flexible support 6 and the bar 1 being lowered, the contact pressure between the flexible support 6 and the surface of the bar 1 can be made uniform. Therefore, a coating layer having a uniform thickness can be formed.

Further, according to the above described embodiment, since the bar pressing devices 20 each having the two driven rubber rollers 21, 21 are disposed at portions of the bar 1 outside of the pair of side plates 15, 15 and each of the portions of the bar 1 outside of the pair of side plates 15, 15 is pressed by the two rubber rollers 21, 21 of the bar pressing device 20, it is possible to prevent the bar 1 from rotating in such a manner that the central portion thereof is eccentric.

Furthermore, according to the above described embodiment, since the upper surface of the base plate 26 is formed with two positioning pins 27, 27 and the lower surface of the first support block 2a is formed with two positioning holes 28, 28, the support block 2 can be located at a predetermined position and fixed to the base plate 26 by positioning the support block 2 so that the two positioning pins 27, 27 of the base plate 26 are inserted into the two positioning holes 28, 28 of the first support block 2a.

The present invention has thus been shown and described with reference to the specific embodiment. However, it should be noted that the present invention is in no way limited to the details of the described arrangements but changes and modifications may be made without departing from the scope of the appended claims.

For example, in the above described embodiment, although the first support block 2a is made of brass, it is not absolutely necessary to make the first support block 2a of brass. It is preferable for the first support block 2a to be made of a material softer than that of the bar 1 in order to prevent the bar 1 from galling and it is preferable for the first support block 2a to be flexible enough to be deformed by the adjusting screw 30. However, the material for forming the first support block 2a is not particularly limited and the first support block 2a may be formed of copper instead of brass.

Furthermore, in the above described embodiment, although the bar 1 is made of stainless steel, it is not absolutely necessary for the bar 1 to be made of stainless steel and the bar 1 may be formed by chromium-plating a carbon steel or the bar 1 may be formed by winding a wire around the outer surface of a bar-like member.

Moreover, in the above described embodiment, although the pair of side plates 15, 15 is made of polytetrafluoroethylene, it is not absolutely necessary for the pair of side plates 15, 15 to be made of polytetrafluoroethylene and the side plates 15, 15 may be formed of another plastic, a metal or alloy softer than that of the bar 1, or the like.

Further, in the above described embodiment, although the doctor blade 10 is made of polyester resin, it is not absolutely necessary for the doctor blade 10 to be made of polyester resin and the doctor blade 10 may be formed of a polyamide resin such as nylon, high-density polyethylene resin or the like.

Furthermore, in the above described embodiment, although the pair of extrusion type solvent extruder 18, 18 is provided outside of the pair of side plates 15, 15 for feeding a solvent capable of dissolving the coating solution onto the surface of the bar 1 from the lower side and the solvent 35 is fed onto the surface of the bar 1 at regions thereof corresponding to regions outside of opposite edge portions of the coating layer to be formed by applying the coating solution onto the flexible support 6, it is not absolutely necessary to use the pair of extrusion type solvent extruder 18, 18 for feeding the solvent 35 capable of dissolving a coating solution onto the surface of the bar 1 at regions thereof corresponding to regions outside of opposite edge portions of the coating layer to be formed by applying the coating solution onto the flexible support 6 and any of various other means can be employed insofar as a solvent 35 capable of dissolving a coating solution can be fed onto the surface of the bar 1 at regions thereof corresponding to regions outside of opposite edge portions of a coating layer to be formed by applying the coating solution onto the flexible support 6.

Moreover, in the above described embodiment, although a solvent 35 accommodated in the solvent tank (not shown) disposed above the bar coating apparatus is fed to the solvent extruders 18, 18 via the pipes 36 utilizing the communicating tube principle, a solvent 35 may be fed to the solvent extruders 18, 18 via the pipes 36 using a driving means such a pump.

Further, in the above described embodiment, although a solvent 35 is fed from the pair of solvent extruders 18, 18 onto the surface of the bar 1, thereby dissolving coating solution which has been scraped off by the doctor blade 10 but remains on the surface of the bar 1 and spreads in the widthwise direction and prevents the coating solution from being point-like adhered to regions of the flexible support 6 which should not be coated with the coating solution, it is not absolutely necessary to provide the doctor blade 10. In the case where the doctor blade 10 is not provided, coating solution accommodated in the spiral groove formed on the surface of the bar 1, coating solution adhered to the surface of the bar 1 or coating solution accompanying the surface of the bar 1 and spreading in the widthwise direction can be dissolved by providing the pair of solvent extruders 18, 18 outside of the pair of side plates 15, 15 and outside of the opposite edge portions of the coating layer of the coating solution to be formed on the surface of the flexible support 6 and feeding a solvent capable of dissolving a coating solution onto the surface of the bar 1, thereby effectively preventing a coating solution from being point-like adhered to regions of the flexible support 6 which should not be coated with the coating solution.

Moreover, in the above described embodiment, although the pair of solvent extruders 18, 18 is provided outside of the pair of side plates 15, 15 and outside of the opposite edge portions of the coating layer of the coating solution to be formed on the surface of the flexible support 6 for feeding a solvent capable of dissolving the coating solution onto the surface of the bar 1, it is not absolutely necessary to provide the pair of solvent extruders 18, 18 outside of the pair of side plates 15, 15 and outside of the opposite edge portions of the coating layer of the coating solution to be formed on the surface of the flexible support 6 for feeding a solvent capable of dissolving the coating solution onto the surface of the bar 1.

Furthermore, in the above described embodiment, although the support block 2 is divided into the first support block 2a, second support block 2b and third support block 2c, it is not absolutely necessary for the support block 2 to be divided into the first support block 2a, second support block 2b and third support block 2c.

Moreover, in the above described embodiment, although the top portion of the second support block 2b is formed so as to have a substantially triangular cross section, it is not absolutely necessary for the top portion of the second support block 2b to be formed so as to have a substantially triangular cross section and the cross section of the top portion of the second support block 2b is not particularly limited insofar as the liquid pool 5 can be formed so as to store a sufficient amount of coating solution therein.

Further, in the above described embodiment, although the doctor blade 10 is fixed to the third support block 2c by inserting it into the space between the first support block 2a and the third support block 2c, and the blade pressing plate 11 until it comes into abutment with a positioning pin 13 penetrating the blade pressing plate 11 and fastening the screw 12 after the doctor blade 10 comes into abutment with the positioning pin 13, the method for fixing the doctor blade 10 is not particularly limited.

Furthermore, in the above described embodiment, although the upper surface of the base plate 26 is formed with two positioning pins 27, 27 and the bottom surface of the first support block 2a is formed with two positioning holes 28, 28, it is not absolutely necessary for the upper surface of the base plate 26 to be formed with two positioning pins 27, 27 and for the bottom surface of the first support block 2a to be formed with two positioning holes 28, 28 and it is possible to form two concave portions on one of the upper surface of the base plate 26 and the bottom surface of the first support block 2a and form two convex portions on the other of the upper surface of the base plate 26 and the bottom surface of the first support block 2a so as to correspond to the concave portions.

Moreover, in the above described embodiment, although the upper surface of the base plate 26 is formed with two positioning pins 27, 27 and the lower surface of the first support block 2a is formed with two positioning holes 28, 28, it is not absolutely necessary for the upper surface of the base plate 26 to be formed with two positioning pins 27, 27 and for the lower surface of the first support block 2a to be formed with two positioning holes 28, 28 and it is possible to form three or more positioning pins on the upper surface of the base plate 26 and form three or more holes on the lower surface of the first support block 2a.

Further, in the above described embodiment, although the adjusting screw 30 is provided at the central portion of the base plate 26 so as to push up the central portion of the lower surface of the first supporting block 2a fixed to the base plate 26, it is not absolutely necessary to provide the adjusting screw 30 at the central portion of the base plate 26.

Moreover, in the above described embodiment, although the bar pressing devices 20 each having the two driven rubber rollers 21, 21 are disposed at portions of the bar 1 outside of the pair of side plates 15, 15 and each of the portions of the bar 1 outside of the pair of side plates 15, 15 is pressed by the two rubber rollers 21, 21 of the bar pressing device 20, it is not absolutely necessary for each of the bar pressing devices 20 to have the two driven rubber rollers 21, 21 and it is possible to provide a pair of rubber rollers rotated by a drive mechanism in each of the bar pressing devices 20 and rotate the pair of rubber rollers at the same peripheral velocity as that of the bar 1.

Furthermore, in the above described embodiment, although the bar pressing devices 20 each having the two driven rubber rollers 21, 21 are disposed at portions of the bar 1 outside of the pair of side plates 15, 15 and each of the portions of the bar 1 outside of the pair of side plates 15, 15 is pressed by the two rubber rollers 21, 21 of the bar pressing device 20, it is sufficient for each of the bar pressing devices 20 to include driven rollers whose surfaces are formed of a high frictional material and it is not absolutely necessary for each of the bar pressing devices 20 to include the driven rubber rollers.

Moreover, in the above described embodiment, although the bar pressing devices 20 each having the two driven rubber rollers 21, 21 are disposed at portions of the bar 1 outside of the pair of side plates 15, 15 and each of the portions of the bar 1 outside of the pair of side plates 15, 15 is pressed by the two rubber rollers 21, 21 of the bar pressing device 20, it is not absolutely necessary to provide the bar pressing devices 20.

According to the present invention, it is possible to provide a bar coating apparatus which can be manufactured at low cost and control the amount of a coating solution transferred onto the surface of a flexible support.

Further, according to the present invention, it is possible to provide a bar coating apparatus which can reliably prevent coating solution accommodated in a spiral groove formed on the surface of a bar, coating solution adhered to the surface of a bar and coating solution accompanying the surface of a bar from being transferred onto the surface of a flexible support, thereby controlling the thickness of a coating layer in a desired manner.

1. A bar coating apparatus including a rotatable bar, a supporting block adapted for supporting the bar and formed with a slit through which the coating solution is fed at an upstream portion of the bar with respect to a transportation direction of a flexible support to be coated with a coating solution and a pair of side plates disposed on the opposite sides of the supporting block with respect to a widthwise direction of the flexible support, the bar, the supporting block and the pair of side plates being disposed so as to form a liquid pool of the coating solution fed through the slit formed in the supporting block in a space defined by the bar, the supporting block and the pair of side plates.

2. A bar coating apparatus in accordance with claim 1, which further comprises a pair of solvent feeding devices disposed outside of the side plates with respect to the widthwise direction of the flexible support and outside of opposite edge portions of a coating layer of the coating solution to be formed on the surface of the flexible support and adapted for feeding a solvent capable of dissolving the coating solution onto the surface of the bar.

3. A bar coating apparatus in accordance with claim 1, which further comprises a doctor blade abutting against the surface of the bar on a side opposite to the slit and having a width larger than that of the liquid pool and the pair of solvent feeding devices is disposed inside of opposite edge portions of the doctor blade.

4. A bar coating apparatus in accordance with claim 2, which further comprises a doctor blade abutting against the surface of the bar on a side opposite to the slit and having a width larger than that of the liquid pool and the pair of solvent feeding devices is disposed inside of opposite edge portions of the doctor blade.

5. A bar coating apparatus in accordance with claim 1, wherein the pair of side plates are disposed inside of opposite edge portions of the flexible support to be coated with the coating solution.

6. A bar coating apparatus in accordance with claim 2, wherein the pair of side plates are disposed inside of opposite edge portions of the flexible support to be coated with the coating solution.

7. A bar coating apparatus in accordance with claim 3, wherein the pair of side plates are disposed inside of opposite edge portions of the flexible support to be coated with the coating solution.

8. A bar coating apparatus in accordance with claim 4, wherein the pair of side plates are disposed inside of opposite edge portions of the flexible support to be coated with the coating solution.

9. A bar coating apparatus in accordance with claim 1, wherein a top portion of the support block has a substantially triangular shaped cross section at an upstream portion of the bar.

10. A bar coating apparatus in accordance with claim 2, wherein a top portion of the support block has a substantially triangular shaped cross section at an upstream portion of the bar.

11. A bar coating apparatus in accordance with claim 3, wherein a top portion of the support block has a substantially triangular shaped cross section at an upstream portion of the bar.

12. A bar coating apparatus in accordance with claim 1, wherein the support block includes a first support block for supporting the bar and a second support block whose top portion has a substantially triangular shaped cross section, the slit is formed between the first support block and the second support block, and the bar, the first support block, the second support block and the pair of side plates are disposed so that a coating solution fed through the slit formed in the support block forms the liquid pool in a space defined by the bar, the top portion of the second support block and the pair of side plates.

13. A bar coating apparatus in accordance with claim 2, wherein the support block includes a first support block for supporting the bar and a second support block whose top portion has a substantially triangular shaped cross section, the slit is formed between the first support block and the second support block, and the bar, the first support block, the second support block and the pair of side plates are disposed so that a coating solution fed through the slit formed in the support block forms the liquid pool in a space defined by the bar, the top portion of the second support block and the pair of side plates.

14. A bar coating apparatus in accordance with claim 3, wherein the support block includes a first support block for supporting the bar and a second support block whose top portion has a substantially triangular shaped cross section, the slit is formed between the first support block and the second support block, and the bar, the first support block, the second support block and the pair of side plates are disposed so that a coating solution fed through the slit formed in the support block forms the liquid pool in a space defined by the bar, the top portion of the second support block and the pair of side plates.

15. A bar coating apparatus in accordance with claim 4, wherein the support block includes a first support block for supporting the bar and a second support block whose top portion has a substantially triangular shaped cross section, the slit is formed between the first support block and the second support block, and the bar, the first support block, the second support block and the pair of side plates are disposed so that a coating solution fed through the slit formed in the support block forms the liquid pool in a space defined by the bar, the top portion of the second support block and the pair of side plates.

16. A bar coating apparatus in accordance with claim 5, wherein the support block includes a first support block for supporting the bar and a second support block whose top portion has a substantially triangular shaped cross section, the slit is formed between the first support block and the second support block, and the bar, the first support block, the second support block and the pair of side plates are disposed so that a coating solution fed through the slit formed in the support block forms the liquid pool in a space defined by the bar, the top portion of the second support block and the pair of side plates.

17. A bar coating apparatus in accordance with claim 6, wherein the support block includes a first support block for supporting the bar and a second support block whose top portion has a substantially triangular shaped cross section, the slit is formed between the first support block and the second support block, and the bar, the first support block, the second support block and the pair of side plates are disposed so that a coating solution fed through the slit formed in the support block forms the liquid pool in a space defined by the bar, the top portion of the second support block and the pair of side plates.

18. A bar coating apparatus in accordance with claim 7, wherein the support block includes a first support block for supporting the bar and a second support block whose top portion has a substantially triangular shaped cross section, the slit is formed between the first support block and the second support block, and the bar, the first support block, the second support block and the pair of side plates are disposed so that a coating solution fed through the slit formed in the support block forms the liquid pool in a space defined by the bar, the top portion of the second support block and the pair of side plates.

19. A bar coating apparatus in accordance with claim 8, wherein the support block includes a first support block for supporting the bar and a second support block whose top portion has a substantially triangular shaped cross section, the slit is formed between the first support block and the second support block, and the bar, the first support block, the second support block and the pair of side plates are disposed so that a coating solution fed through the slit formed in the support block forms the liquid pool in a space defined by the bar, the top portion of the second support block and the pair of side plates.

20. A bar coating apparatus in accordance with claim 12, wherein the first support block is made of a metal softer than that of the bar.
